(19) United States
(12) Patent Application Publication
(10) Pub. No.: US 2023/0004239 A1
(43) Pub. Date: Jan. 5, 2023

(54) ELECTRONIC PEN AND ELECTRONIC PEN CENTRAL ROD

(71) Applicant: Wacom Co., Ltd., Saitama (JP)

(72) Inventors: Masayuki MAEDA, Saitama (JP); Tomohiro KAMAI, Saitama (JP)

(21) Appl. No.: 17/732,267

(22) Filed: Apr. 28, 2022

(30) Foreign Application Priority Data
Jun. 30, 2021 (JP) 2021-108304

(51) Int. Cl. G06F 3/0354

(52) U.S. Cl. CPC G06F 3/03545

(57) ABSTRACT

An electronic pen includes a central rod including an axis portion and a pen tip portion, the axis portion having a rod-shaped body and one or more grooves defined along a circumference of a side surface on one end side of the rod-shaped body, and the pen tip portion including a hole into which the one end side of the axis portion is plugged and including one or more protrusions defined on an inner wall surface of the hole, wherein the one or more protrusions are to be fitted to the one or more grooves of the axis portion. The electronic pen includes a casing that is a cylindrical body, that includes an opening at one end, and that includes an installation portion for the central rod inside. When a rear end side of the central rod is inserted into the opening of the casing and installed on the installation portion, at least one of the one or more grooves of the axis portion of the central rod are positioned outside the opening of the casing.

### BACKGROUND

### Technical Field

The disclosure relates to an electronic pen used as a position indicator for a position detection apparatus mounted on an electronic device, such as a tablet PC (Personal Computer) and a smartphone, and to an electronic pen central rod used in the electronic pen.

### Description of the Related Art

A position detection apparatus and a position indicator are used as input devices of an electronic device such as a tablet PC or a high-performance phone terminal called a smartphone. The position indicator is generally formed in a pen shape, and the position indicator is called an electronic pen, a stylus, or the like. In the specification, the position indicator formed in a pen shape will be referred to as an electronic pen. A central rod of the electronic pen affects the feel (or sense) of writing (what it feels like to write), and the central rod is an important constituent member of the electronic pen. An operation surface (input surface) of the electronic device touched by a pen tip of the central rod of the electronic pen is made of glass, resin, or the like. Therefore, the pen tip may get caught due to the friction between the pen tip of the central rod and the operation surface, or the pen tip may be worn out. These factors are taken into account to make various innovations for the central rod.

For example, an invention disclosed in Japanese Patent Laid-Open No. 2015-26359 (hereinafter, Patent Document 1) provides a central rod including: a tip portion including an elastic member; a base portion made of a material harder than the elastic member material forming the tip portion; and a central rod portion thinner than the base portion. In the case of the central rod disclosed in Patent Document 1, the feel of writing can be changed, and the friction with the operation surface of the electronic device can be reduced. To suppress the abrasion caused by the friction with the operation surface, the applicant of the present application has studied mixing fibers formed from polyparaphenylene terephthalamide with resin to form an electronic pen central rod, and the applicant has already filed an international patent application (International Patent Application PCT/JP2021/003508) covering the discovery.

In recent years, the electronic pen is also downsized and miniaturized along with downsizing of the electronic device provided with the position detection apparatus, and the electronic pen central rod is also miniaturized accordingly. However, if the strength is reduced by miniaturizing the central rod, the central rod could be easily damaged, and a sturdy miniaturized electronic pen cannot be realized. It is desirable that the electronic pen central rod have an excellent feel of writing, the operation surface of the electronic device not be damaged, and the abrasion of the pen tip of the central rod be reduced. It is also desirable to make manufacturing of the electronic pen central rod as easy as possible. In short, there are issues to be solved in miniaturizing the electronic pen central rod, such as improvement of strength, improvement in the feel of writing, protection of the operation surface (input surface) of the electronic device, reduction in abrasion of the pen tip, and simplification of manufacturing.

However, in the case of the invention disclosed in Patent Document 1, because so-called two-color molding (thermal welding) is used to integrally form the tip portion, the base portion, and the central rod portion together to make the electronic pen central rod, all of the portions need to be made of a resin material. Therefore, the strength may not be sufficient when the electronic pen central rod is miniaturized. In addition, the entire electronic pen central rod is also made of resin when the fibers formed from polyparaphenylene terephthalamide are mixed with the resin to form the electronic pen central rod in order to suppress the abrasion caused by the friction with the operation surface, and in this case also the strength becomes a concern when the electronic pen central rod is miniaturized. As an initial matter, it is difficult to make a miniaturized central rod portion (axis portion) using the resin mixed with fibers.

### BRIEF SUMMARY

In view of the above, an aspect of the disclosure is directed to realizing a highly reliable electronic pen that can sufficiently withstand hard use even when the electronic pen is miniaturized and that can be easily manufactured.

To solve the problems, provided is an electronic pen including a central rod including an axis portion that is a rod-shaped body and that is provided with a groove along a circumference of a side surface on one end side. The central rod also includes a pen tip portion that includes a hole into which said one end side of the axis portion is plugged and that is provided with a protrusion on an inner wall surface of the hole, the protrusion being fitted to the groove of the axis portion. The central rod also includes a casing that is a cylindrical body and that includes an opening at one end and also includes an installation portion for the central rod inside. When a rear end side of the central rod is inserted into the opening of the casing and installed on the installation portion, the groove of the axis portion of the central rod is positioned outside the opening of the casing.

According to the electronic pen, the axis portion and the pen tip portion are different members. A highly strong rod-shaped body can be used as the axis portion, and a material with elasticity and friction resistance can be used as the pen tip portion. When one end portion of the axis portion is inserted into the hole of the pen tip portion, the groove of the axis portion and the protrusion of the pen tip portion are fitted so that they do not easily come off from each other. When the central rod is attached inside the casing, the pen tip of the central rod sufficiently protrudes from the casing, and the protrusion of the pen tip portion is fitted to the groove of the axis portion. Therefore, the pen tip portion does not come off of the axis portion even when strong pen pressure is applied.

### BRIEF DESCRIPTION OF THE SEVERAL VIEWS OF THE DRAWINGS

FIG. 1 is a diagram for describing an example of an electronic device provided with an input apparatus including a position detection apparatus and an electronic pen;

FIGS. 2A and 2B are diagrams describing a configuration example of the electronic pen according to an embodiment;

FIGS. 3A to 3C are diagrams describing a configuration of an electronic pen central rod according to the embodiment;

FIG. 4 is a diagram describing a method of installing the electronic pen central rod on a casing of the electronic pen according to the embodiment; and

FIGS. 5A and 5B are diagrams describing another configuration example of a pen tip portion of the electronic pen central rod in the electronic pen according to the embodiment.

### DETAILED DESCRIPTION

Embodiments of an electronic pen and an electronic pen central rod of the disclosure will now be described with reference to the drawings.

### Specific Example of Electronic Device

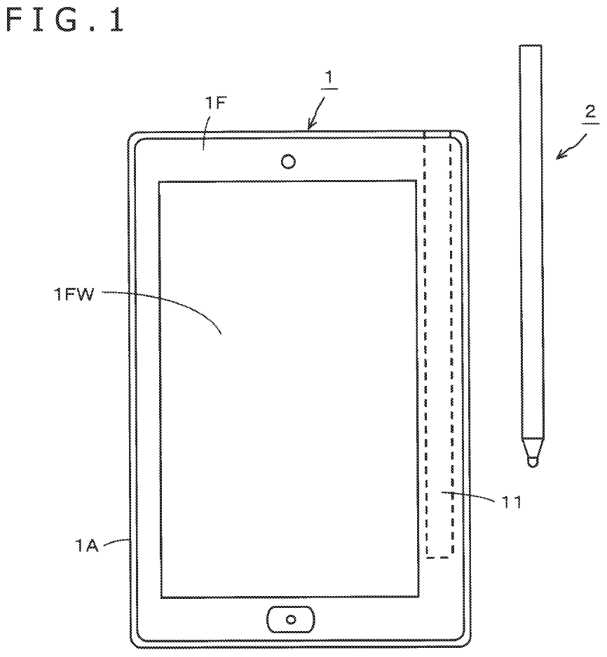

FIG. 1 illustrates an example of an electronic device that is provided with a position detection apparatus and that allows an electronic pen used for the position detection apparatus to input an instruction. Note that the following describes one embodiment of the electronic pen and the electronic pen central rod in which the invention is applied to an electronic pen and an electronic pen central rod. The electronic device of the embodiment is a tablet PC or a smartphone (high-performance mobile phone terminal) including a display apparatus, such as an LCD (liquid crystal display), and the electronic device consists of an electronic device body 1 having a position detection apparatus, and an electronic pen 2.

The electronic device body 1 includes an LCD, two position detection sensors with different detection systems, a motherboard, and the like that are layered (arranged on top of each other) between a casing 1A and a front panel 1F. In the embodiment, one of the two position detection sensors with different detection systems is a position detection sensor of an electromagnetic resonance system, and the other is a position detection sensor of a capacitance system.

An opening 1FW is provided on the front panel 1F. The size of the opening 1FW is the same as the size of a display region of a display screen of the LCD and the size of an operation region for receiving an input of a user using the electronic pen 2 or the like. Note that, in the embodiment, the operation region 1FW corresponding to the display region of the LCD may be referred to as an operation surface on which the electronic pen 2 is brought into contact to perform an input operation. A housing portion 11 described later to house the electronic pen 2 is provided on the casing 1A of the electronic device body 1, and the electronic pen 2 is housed in the housing portion 11 when the electronic pen 2 is not in use.

The electronic pen 2 is used for inputting information through the position detection sensor of the electromagnetic resonance system. The user takes out the electronic pen 2 housed in the housing portion 11 as necessary to perform a position indication operation on the operation region 1FW. The electronic pen 2 is suitable for inputting detailed information, such as inputting a diagram or a drawing. The electronic device body 1 is provided with the position detection sensor of the capacitance system, and the user can bring a finger into contact with the operation region 1FW to mainly perform an operation such as selecting an icon or a display button. Needless to say, the user can bring the finger into contact with the operation region 1FW to input a drawing or handwritten characters through the position detection sensor of the capacitance system.

Assuming that the electronic pen 2 is operated on the operation region 1FW of the electronic device body 1, the position detection sensor of the electromagnetic resonance system provided inside the electronic device body 1 detects the position pointed to by the electronic pen 2 and the pen pressure. In response to this, a control circuit for display and the like (microcomputer) of the electronic device body 1 controls the display process on the display screen of the LCD. Similarly, assuming that the user uses a finger or the like to perform an operation on the operation region 1FW of the electronic device body 1 in the electronic device, the position detection sensor of the capacitance system, which is provided inside the electronic device body 1, detects the position indicated (pointed to) by the finger or the like. In response to this, the control circuit for display and the like of the electronic device body 1 controls the display process on the display screen of the LCD.

As described above, the electronic pen 2 functions relative to the position detection sensor of the electromagnetic resonance system. Although described in detail later, the electronic pen 2 is provided with a coil and a capacitor (capacitor element) included in a resonant circuit. In the electronic device of the embodiment, whether or not the electronic pen 2 is housed in the housing portion 11 of the electronic device body 1 can be detected by, for example, a mechanical switch or by transmission and reception of signals through electromagnetic induction with the coil of the resonant circuit of the electronic pen 2. In this way, when the electronic pen 2 is housed in the housing portion 11, the position detection sensor of the electromagnetic resonance system is not activated and the position indicated by the electronic pen 2 is not detected, so as to reduce the power consumption by the electronic device body 1.

### Configuration Example of Electronic Pen

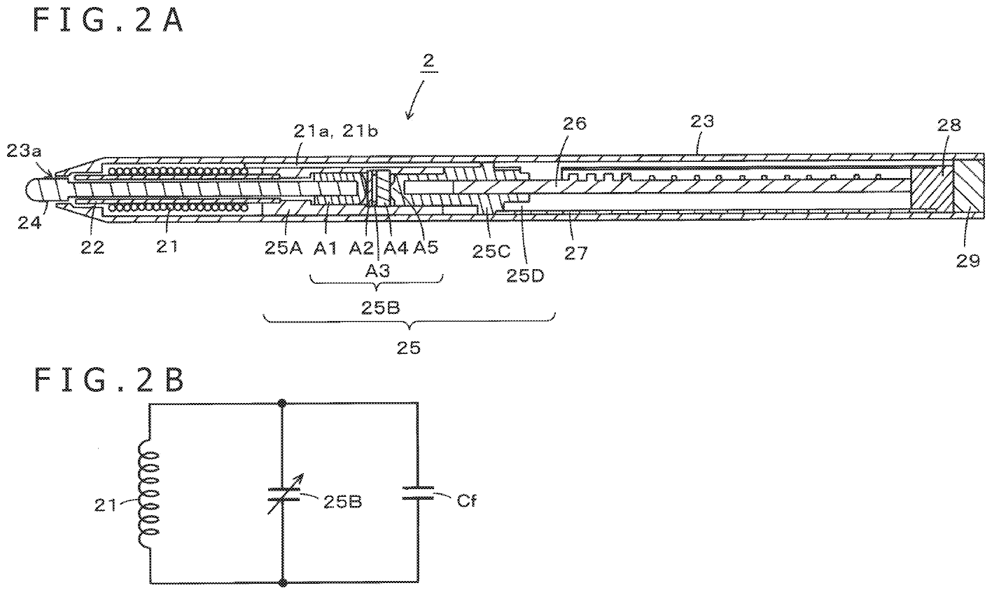

A configuration example of the electronic pen 2 that indicates the position to the position detection sensor of the electromagnetic resonance system mounted on the electronic device body 1 illustrated in FIG. 1 will be described. FIGS. 2A and 2B are diagrams describing the configuration example of the electronic pen 2 of the embodiment. FIG. 2A illustrates a cross-sectional view of the electronic pen 2, and FIG. 2B illustrates an equivalent circuit of the electronic pen 2.

As illustrated in FIGS. 2A and 2B, various members for realizing the electronic pen function are mounted in a casing 23 to provide the electronic pen 2. A ferrite core 22 is made, for example, by forming a through hole in a columnar ferrite material along its axial direction, wherein the through hole is formed at a position including a center line in the axial direction and has a predetermined diameter (for example, diameter=1 mm) for inserting therethrough a rod-shaped central rod 24 to be described in detail later.

The central rod 24 is inserted into the through hole of the ferrite core 22 such that the central rod 24 penetrates the ferrite core 22. That is, the central rod 24 is longer than the length of the ferrite core 22 in the axial direction. The diameter of the portion of the central rod 24 inserted into the through hole of the ferrite core 22 is slightly shorter than the diameter of the through hole, and the central rod 24 can slide in the axial direction in the through hole. Note that the diameter of an end part (pen tip portion) that is the pen tip of the central rod 24 is longer than the diameter of the through hole of the ferrite core 22, and a front end portion is processed into a hemispherical shape such that it can smoothly move on the operation surface (operation region) of a touch panel or the like.

As illustrated in FIG. 2A, a predetermined length portion of the ferrite core 22 including its center point along the axial direction is a coil winding section around which a coil 21 is wound in the axial direction, and parts on both sides of the coil winding section are coil non-winding sections around which the coil is not wound. That is, when the ferrite core 22 is viewed in the axial direction, a part from an end portion on the pen tip side to an end portion of the coil winding section on the pen tip side is a first coil non-winding section around which the coil is not wound. A part from the other end of the coil winding section to an end portion of the ferrite core 22 opposite from the pen tip side is a second coil non-winding section around which the coil 21 is not wound.

Extension lines (conductor lines) 21a and 21b from both ends of the coil 21 wound around the ferrite core 22 are extended inside the casing 23, up to a printed board 26 described later. The extension lines 21a and 21b are connected to a capacitor Cf provided on the printed board 26. In this way, the coil 21 and the capacitor Cf on the printed board 26 form a resonant circuit, and signals can be transmitted and received to and from the position detection apparatus of the electromagnetic resonance system through electromagnetic induction.

On the opposite side from the pen tip of the central rod 24, a connection portion 25 is provided that includes a mold portion 25A, a pen pressure detection portion 25B, a fitting portion 25C, and a connection terminal portion 25D. The connection portion 25 is a part that integrally connects a part of the pen tip side including the coil 21, the ferrite core 22, and the central rod 24 with the printed board 26 and a board protection pipe 27 described later. The mold portion 25A is a cylindrical part made of resin or the like, and an outer circumference of an end surface of the mold portion 25A on the ferrite core 22 side is slightly larger than an outer circumference of the coil winding section of the ferrite core 22. A recessed portion for fitting the second coil non-winding section of the ferrite core 22 is provided on the end surface side of the mold portion 25A facing the ferrite core 22.

Additionally, a central rod holding portion A1, a conductive rubber A2, a ring spacer A3, a dielectric A4, and a terminal member A5 are provided inside the mold portion 25A as illustrated in FIG. 2A. These portions are placed between the mold portion 25A and the fitting portion 25C described later to provide the pen pressure detection portion 25B that detects the pen pressure.

Specifically, the central rod holding portion A1 is formed in a cup shape from, for example, hard rubber. An end part of the central rod 24 on the opposite side from the pen tip side is plugged in, and the central rod holding portion A1 holds the end part. A bottom portion of the central rod holding portion A1 on the opposite side from the central rod 24 is formed in a spherical shape. The central rod holding portion A1 functions as a pressing portion that presses the conductive rubber A2 according to the pen pressure applied to the central rod 24. The conductive rubber A2 has a predetermined thickness, and the shape and the size of the conductive rubber A2 are the same as those of the opposing surface of the dielectric A4. The surface of the conductive rubber A2 on the pen tip side faces the spherical bottom portion of the central rod holding portion A1, and the other surface faces one surface of the dielectric A4 through the ring spacer A3.

The ring spacer A3 is a member formed in a ring shape, and an air gap corresponding to the thickness of the ring spacer A3 is provided between the conductive rubber A2 and the surface of the dielectric A4 on the pen tip side to isolate (separate) them from each other. The dielectric A4 is formed from a substance, such as ceramic, in which the dielectric properties are dominant over the conductivity, and the dielectric A4 acts as an insulator that does not conduct electricity with DC voltage. On the other surface of the dielectric A4, the terminal member A5 having a predetermined area is pasted. In this way, the dielectric A4 is placed between the conductive rubber (first electrode) A2 and the terminal member (second electrode) A5, to thereby form a variable capacitor.

That is, the central rod 24 slides up and down in the axial direction according to the pen pressure applied to the pen tip of the central rod 24. In conjunction with this, the central rod holding portion A1 pushes up and down the conductive rubber A2. An air gap is provided by the ring spacer A3 between the conductive rubber A2 and the dielectric A4. Therefore, the conductive rubber A2 approaches and comes into contact with the dielectric A4 according to the pressure applied to the central rod 24, and the contact area of the conductive rubber A2 changes. In this way, the capacitance between the conductive rubber A2 and the terminal member A5 sandwiching the dielectric A4 changes according to the pen pressure. Note that, when the pen pressure is not applied, the conductive rubber A2 is separated from the dielectric A4 due to the existence of the ring spacer A3.

A conductive line connected to the conductive rubber A2 and a conductive line connected to the terminal member A5 extend outside of the mold portion 25A and the fitting portion 25C, for example, to be connected to a terminal of the connection terminal portion 25D described later, and to be connected to an electronic circuit of the printed board 26 through the terminal of the connection terminal portion 25D. In this way, the electronic circuit section of the printed board 26 can detect, as a change in capacitance of the variable capacitor configured as described above, the pen pressure applied to the central rod 24.

In the example, the pen pressure detection portion 25B including the central rod holding portion A1, the conductive rubber A2, the ring spacer A3, the dielectric A4, and the terminal member A5 is similar to a pen pressure detection section with a well-known configuration described in, for example, Japanese Patent Laid-Open No. Hei 5-275283. The configuration of the pen pressure detection portion 25B can also be similar to a pen pressure detection section with a well-known configuration described in Japanese Patent Laid-Open No. 2011-186803. A semiconductor element disclosed in, for example, Japanese Patent Laid-Open No. 2013-161307 can also be used, in which the capacitance is variable according to the pen pressure.

The fitting portion 25C is a part fitted to the board protection pipe 27 described later. The fitting portion 25C is formed in, for example, a substantially cylindrical shape from resin, hard rubber, or the like, and the fitting portion 25C is firmly fitted and integrated with the mold portion 25A. In this way, the central rod holding portion A1, the conductive rubber A2, the ring spacer A3, the dielectric A4, and the terminal member A5 are placed between the mold portion 25A and the fitting portion 25C as also described above, and the pen pressure detection portion 25B including these members is secured in the casing 23.

A recessed portion for fitting a tip portion of the printed board 26 described later is provided inside the fitting portion 25C. Note that the outer diameter of the fitting portion 25C is slightly longer than the inner diameter of the board protection pipe 27, and the fitting portion 25C can be firmly fitted to the board protection pipe 27. When the board protection pipe 27 is fitted to the fitting portion 25C, the outer circumference of the board protection pipe 27 coincides with the outer circumference of the fitting portion 25C and the mold portion 25A.

The connection terminal portion 25D is a part including an upper plate portion and a lower plate portion both being coupled to the fitting portion 25C, as illustrated in FIG. 2A. The printed board 26 described later is placed between the two plate portions. In this case, the gap between the upper plate portion and the lower plate portion is slightly narrower than the thickness of the printed board 26, and the printed board 26 is sandwiched in between.

On one of the two plate portions, such as the upper plate portion in FIG. 2A, the terminal connected to the conductive lines from the conductive rubber A2 and from the terminal member A5 is provided to wrap around the end surface of the circuit board side from the upper surface to the lower surface. Therefore, the connection terminal portion 25D is automatically connected to the terminal section of the electronic circuit provided on the printed board 26 when the printed board 26 is plugged into the connection terminal portion 25D.

The printed board 26 is formed by mounting terminals for the electronic circuit and various circuit parts as well as their connection wires as described above on a rectangular insulating board. The various circuit parts include an IC (integrated circuit) that functions as a control circuit, a plurality of capacitors Cf, and the like. The printed board 26 is housed and protected in the board protection pipe 27 as illustrated in FIG. 2A.

A metal, a carbon material, a synthetic resin, or the like is used to form the board protection pipe 27, and the board protection pipe 27 is a hard tubular member that is less likely to be bent or curved. The board protection pipe 27 includes a central rod side opening and a rear end side opening at its two ends. The central rod side opening and the rear end side opening are openings in a direction crossing the axial direction. The fitting portion 25C of the connection portion 25 is plugged from the central rod side opening into a part extending for a predetermined range inside the board protection pipe 27, and they are fitted to each other. Similarly, a pipe lid 28 is plugged from the rear end side opening into a part extending for a predetermined range inside the board protection pipe 27, and they are fitted. The pipe lid 28 is also provided with a recessed portion for plugging the end portion of the printed board 26.

In this way, the central rod 24 is inserted into an opening 23a of the casing 23 from the rear end, and the central rod 24 is plugged into the central rod holding portion A1. The central rod 24 is installed in the casing 23 such that the part of the central rod 24 on the tip side protrudes from the casing 23. That is, the central rod holding portion A1 provides an installation portion of the central rod 24. In this case, the part of the pen tip side in which the central rod 24 is inserted into the ferrite core 22 around which the coil 21 is wound, the connection portion 25, the board protection pipe 27 housing the printed board 26, and the pipe lid 28 are integrally connected and housed in the casing 23 to provide the electronic pen 2.

FIG. 2B illustrates an equivalent circuit of the electronic pen 2 according to the embodiment. That is, the coil 21, the pen pressure detection portion 25B including a variable capacitor, and the capacitor Cf on the printed board 26 are connected in parallel to provide a resonant circuit. In this way, signals can be transmitted and received to and from the position detection apparatus including the position detection sensor of the electromagnetic resonance system, to be described later.

### Configuration Example of Electronic Pen Central Rod

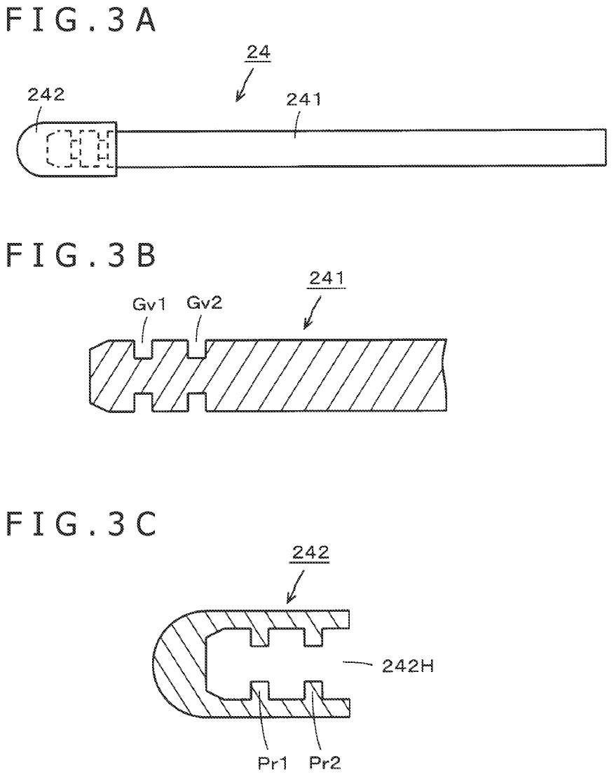

FIGS. 3A to 3C are diagrams describing a configuration of the electronic pen central rod (hereinafter, simply referred to as “central rod”) 24 of the embodiment. As illustrated in an external view of FIG. 3A, the central rod 24 includes an axis portion 241 that is a rod-shaped body and a pen tip portion 242 in a cup shape, in which a tip is processed into a hemispherical shape. A hole is provided on a rear end side of the pen tip portion 242.

In the embodiment, the axis portion 241 is made of a carbon material. The strength of the carbon material is ten times the strength of iron, and the carbon material is less likely to be bent. The carbon material is also excellent in abrasion resistance, heat resistance, thermal expansion and contraction, acid resistance, and electrical conductivity, and the carbon material is suitable as a material for forming the axis portion 241 of the central rod 24 to be miniaturized. The pen tip portion 242 is made of, for example, a polyacetal resin (what is called POM). The polyacetal resin is self-lubricating, and the coefficient of friction is small. Therefore, the polyacetal resin has excellent friction characteristics. Therefore, the pen tip portion 242 thus configured is unlikely to damage the operation surface when the pen tip portion 242 comes into contact with the operation region (operation surface) 1FW of the electronic device body 1 to perform an input operation, and the pen tip portion 242 is unlikely to be abraded significantly. The polyacetal resin is also very strong and is excellent in impact resistance. Therefore, the polyacetal resin is suitable as a material for forming the pen tip portion 242 of the central rod 24 to be miniaturized.

As illustrated in FIG. 3A, the axis portion 241 is plugged into the hole of the cup-shaped pen tip portion 242 to provide a unitary central rod 24. As illustrated in a cross-sectional view of one end side (pen tip side) of the axis portion 241 in FIG. 3B, grooves Gv1 and Gv2 are provided along the circumference of the side surface the pen-tip-side end part of the axis portion 241. The grooves Gv1 and Gv2 are recessed portions provided in a ring shape around the side surface of the axis portion 241, at different positions in the longitudinal direction of the axis portion 241.

As illustrated in a cross-sectional view of the pen tip portion 242 in FIG. 3C, the pen tip portion 242 is provided with a hole 242H into which one end side (pen tip side) of the axis portion 241 is plugged. Protrusions Pr1 and Pr2 in a ring shape are provided on the inner wall surface of the hole 242H, along the inner wall surface. The protrusions Pr1 and Pr2 are provided at positions corresponding to the grooves Gv1 and Gv2 of the axis portion 241 when the axis portion 241 is plugged into the hole 242H. Therefore, when the pen-tip-side end portion of the axis portion 241 is inserted into the hole 242H of the pen tip portion 242, the protrusion Pr1 of the pen tip portion 242 is fitted to the groove Gv1 of the axis portion 241, and the protrusion Pr2 of the pen tip portion is fitted to the groove Gv2 of the axis portion 241.

In this way, the protrusions Pr1 and Pr2 provided on the inner wall surface of the hole 242H of the pen tip portion 242 can be fitted to two grooves Gv1 and Gv2 separated in the longitudinal direction of the axis portion 241 to thereby firmly attach the pen tip portion 242 to the axis portion 241. The pen tip portion 242 can be easily and firmly attached to the axis portion 241 to provide the central rod 24, by merely applying a small force to plug the side provided with the grooves Gv1 and Gv2 of the axis portion 241 into the hole 242H of the pen tip portion 242.

### Installation Mode of Central Rod

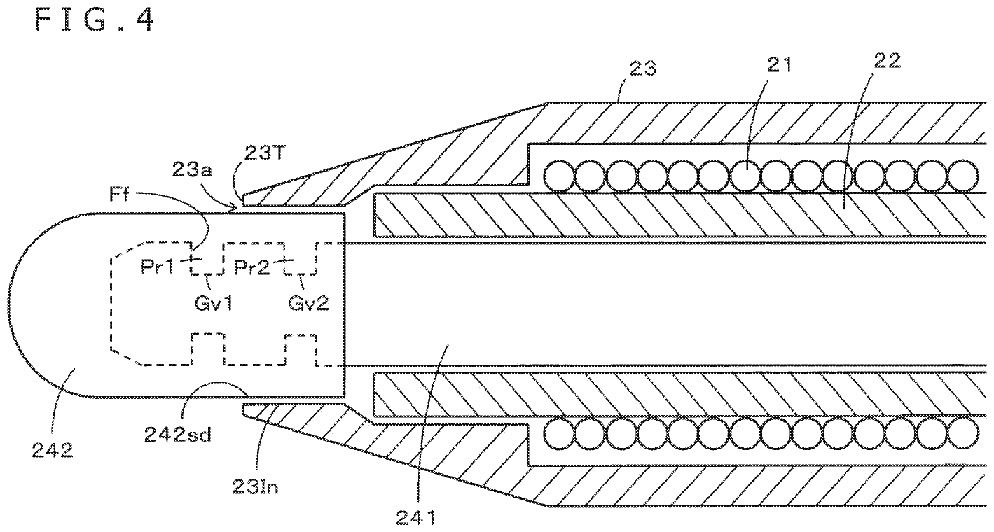

FIG. 4 is a diagram describing a mode of installing the electronic pen central rod on the casing of the electronic pen according to the embodiment. As described with reference to FIGS. 2A and 2B, the central rod 24 is installed (attached) inside the casing 23 by inserting the central rod 24 into the opening 23a of the casing 23 from the rear end and plugging the central rod 24 into the central rod holding portion A1. In this case, the tip side of the pen tip portion 242 of the central rod 24 protrudes from the opening 23a of the casing 23, and at least the groove Gv1 of the axis portion 241 is positioned outside the opening 23a of the casing 23 as illustrated in FIG. 4.

That is, a front end surface Ff of the groove Gv1 in the axis portion 241 of the central rod 24 is positioned to the left of a tip surface 23T of the casing 23, and the entire groove Gv1 is positioned outside the casing 23 in FIG. 4. In this way, the tip side of the pen tip portion 242 of the central rod 24 can sufficiently protrude from the casing 23. The groove Gv1 of the axis portion 241 and the protrusion Pr1 of the pen tip portion 242 are fitted outside the casing 23, such that the pen tip portion 242 does not come off of the axis portion 241 even when relatively strong pen pressure is applied to the pen tip portion 242 of the central rod 24.

Although the number of groove(s) can be one, the pen tip portion 242 may come off due to an impact or the like when there is only one groove as described later. When only the axis portion 241 remains inserted in the pen after the pen tip portion 242 comes off, the blade of a knife or the like can be hooked to remove the axis portion 241 of the central rod from the pen if the groove Gv1 is outside the opening 23a. That is, the groove Gv1 can function as a hook portion for removing the axis portion 241 of the central rod 24.

A predetermined part of the rear end side of the pen tip portion 242 in the central rod 24 of the embodiment is positioned inside the casing 23 when the rear end side of the central rod 24 is inserted into the opening 23a of the casing 23 and installed on the central rod holding portion A1. In the case of the example illustrated in FIG. 4, the part slightly behind the protrusion Pr1 to be fitted to the groove Gv1 is positioned in the casing 23. In the case of the central rod 24 of the embodiment, the groove Gv1 of the axis portion 241 and the protrusion Pr1 of the pen tip portion 242 are fitted outside the casing 23, and the groove Gv2 of the axis portion 241 and the protrusion Pr2 of the pen tip portion 242 are fitted inside the casing 23 as illustrated in FIG. 4.

Therefore, the groove Gv2 of the axis portion 241 and the protrusion Pr2 to be fitted to the groove Gv2 are positioned in the casing 23. This can more firmly attach the pen tip portion 242 to the axis portion 241. This can also prevent the pen tip portion 242 from easily coming off of the axis portion 241 and can prevent damage to the pen tip portion 242. For example, assuming that the entire pen tip portion 242 attached to the axis portion 241 protrudes from the casing 23, the pen tip portion 242 may come off of the axis portion 241, or the rear part of the pen tip portion 242 may be damaged when, for example, something gets caught on the rear end surface of the pen tip portion 242 attached to the axis portion 241. However, in the case of the electronic pen 2 of the embodiment, the predetermined part of the rear end side of the pen tip portion 242 is positioned inside the casing 23 as illustrated in FIG. 4. Therefore, the pen tip portion 242 does not easily come off, and the rear end side of the pen tip portion 242 is not damaged.

In the electronic pen 2, the rear end side of the central rod 24 can be inserted into the opening 23a of the casing 23 and installed on the central rod holding portion A1. In this case, a side surface 242Sd at a predetermined portion of the rear end side of the pen tip portion 242 and an inner wall surface 23In at a portion of the opening 23a of the casing 23 are slightly spaced apart and face each other in parallel. As also described above, the central rod 24 attached in the casing 23 slides and is pushed into the casing 23 when pen pressure is applied in the axial direction (the longitudinal direction of the electronic pen 2). The pen pressure can be appropriately detected by the pen pressure detection portion 25B. When the pen pressure is released, the central rod 24 pushed into the casing 23 is pushed out and returns to the original position.

In this case, the side surface 242Sd at the predetermined portion of the rear end side of the pen tip portion 242 and the inner wall surface 23In at the portion of the opening 23a of the casing 23 are slightly spaced apart and face each other in parallel. Therefore, they do not come into contact with each other, and the central rod 24 can repeatedly slide in and out of the casing 23 according to the pen pressure without stress. Accordingly, the pen pressure can be correctly detected and provided to the position detection apparatus of the electromagnetic resonance system of the electronic device body 1.

### Another Configuration Example of Pen Tip Portion 242

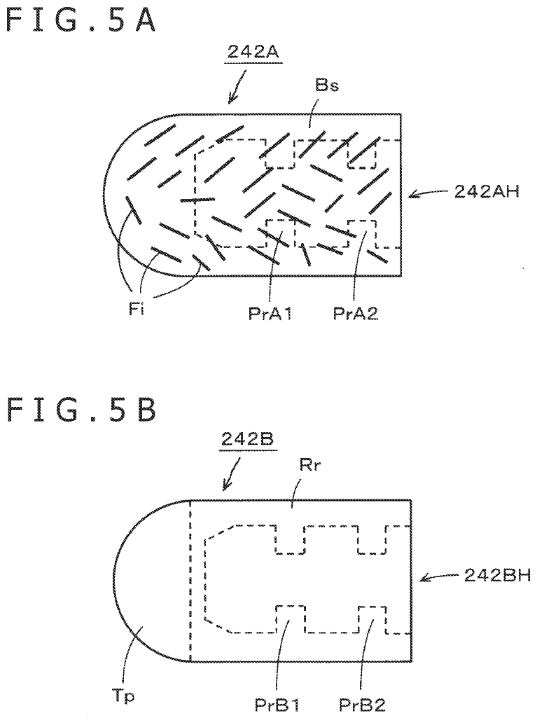

FIGS. 5A and 5B are diagrams describing another configuration example of the pen tip portion of the electronic pen central rod in the electronic pen according to the embodiment. Although the pen tip portion 242 of the central rod 24 is formed from a polyacetal resin in the embodiment described above, the resin is not limited to this. For example, various resins, such as a PA (polyamide) resin, a PET (polyethylene terephthalate) resin, a PC (polycarbonate) resin, and an ABS (acrylonitrile butadiene styrene) resin, can be used to form the pen tip portion 242.

Instead of simply using one type of resin to form the pen tip portion 242, a fibrous material can be mixed with one of the base resins, and the fibrous material mixed resin may be used to form the pen tip portion 242. The electronic pen 2 is used by bringing the pen tip portion 242 into contact with the operation region (operation surface) 1FW of the electronic device body 1, and the fibrous material can be mixed with the base resin to reduce the abrasion of the pen tip portion 242.

FIG. 5A is a diagram describing a pen tip portion 242A formed of the fibrous material mixed resin that is made by mixing a fibrous material with a base resin Bs. Note that the pen tip portion 242A illustrated in FIG. 5A also includes a hole 242AH for plugging the axis portion 241 as in the pen tip portion 242 illustrated in FIG. 3C. Protrusions PrA1 and PrA2 corresponding to the grooves Gv1 and Gv2 provided on one end portion of the axis portion 241 are provided on the inner wall surface of the hole 242AH as illustrated in FIG. 5A.

The pen tip portion 242A illustrated in FIG. 5A is formed by mixing polyparaphenylene terephthalamide (Kevlar (registered trademark)) fibers as a fibrous material Fi with the polyacetal resin as a base resin Bs. As also described above, the polyacetal resin has excellent friction characteristics. The polyparaphenylene terephthalamide fibers are very strong, highly heat-resistant, and flexible. Therefore, the pen tip portion 242A formed from the fibrous material mixed resin including the polyparaphenylene terephthalamide fibers mixed with the polyacetal resin can reduce the abrasion caused by use, and the pen tip portion 242A does not damage the operation region (operation surface) 1FW. Needless to say, the friction characteristics of the polyacetal resin do not deteriorate such that application of excessive load and damage to the operation region (operation surface) 1FW of the electronic device body 1 can be reduced.

Note that the fibers included in the pen tip portion 242 are mixed with the resin so that the fibers are arranged approximately along the curved surface of the pen tip portion. In this way, the highly strong fibers do not damage the operation region (operation surface) 1FW even when the resin is worn out by abrasion.

Instead of simply using one type of resin to form the pen tip portion 242, two types of resins may be used to form the pen tip portion 242. For example, a PET resin can be used to form the rear end side of the pen tip portion 242, and a polyacetal resin can be used to form the tip side. FIG. 5B is a diagram describing a pen tip portion 242B formed by what is called two-color molding using different resins for a tip part Tp and a rear part Rr. Note that the pen tip portion 242B illustrated in FIG. 5B also includes a hole 242BH for plugging the axis portion 241 as in the pen tip portion 242 illustrated in FIG. 3C. Protrusions PrB1 and PrB2 corresponding to the grooves Gv1 and Gv2 provided on one end portion of the axis portion 241 are provided on the inner wall surface of the hole 242BH as illustrated in FIG. 5A.

An elastomer is used for the tip part Tp, and a polyacetal is used for the rear part Rr to form the pen tip portion 242B illustrated in FIG. 5B. The elastomer is a generic term of elastic macromolecules, and what is called rubber is equivalent to this. Specifically, there are various elastomers, such as natural rubber, synthetic rubber, urethane rubber, silicone rubber, and fluororubber. In this way, by using the elastomer to form the tip part Tp, a softer feel can be attained when the pen tip comes into contact with the operation region (operation surface) 1FW of the electronic device body 1, and what is called the feel (or sense) of writing (what it feels like to write) can be improved.

Note that the two-color molding is different from insert molding in that the two-color molding is a technique of alternately molding and thermally welding resins of different materials or colors in one cycle to create one molded product from two types of resins. The resins of different materials or colors can be firmly connected by thermally welding the resins. Although the resins of different materials or colors are used, a unitary highly-reliable molded product can be produced, in which the resins are not separated. Note that the two-color molding may be called different material molding, a double mode, or the like in some cases.

### Advantageous Effects of Embodiment

In the case of the electronic pen 2 of the embodiment described above, the pen tip portion 242 can be easily attached to the axis portion 241 to provide the central rod 24. In this case, the grooves Gv1 and Gv2 of the axis portion 241 and the protrusions Pr1 and Pr2 on the inner wall surface of the hole 242H of the pen tip portion 242 are fitted, and this can firmly attach the pen tip portion 242 so that the pen tip portion 242 does not easily come off of the axis portion 241. The groove Gv1 of the axis portion 241 of the central rod 24 is positioned outside the opening 23a of the casing 23 when the rear end side of the central rod 24 is inserted into the opening 23a of the casing 23 and installed on the central rod holding portion A1. Therefore, the tip side of the pen tip portion 242 of the central rod 24 can sufficiently protrude from the casing 23, and a user-friendly electronic pen can be realized. This can realize a highly reliable electronic pen that can sufficiently withstand hard use even when the electronic pen is miniaturized and that can be easily manufactured.

A central rod formed by using the pen tip portion 242A or 242B and the axis portion 241 also has these advantageous effects. The use of the pen tip portion 242A can further reduce the abrasion and allow for miniaturization of a central rod having a long lifespan. The use of the pen tip portion 242B can realize a miniaturized central rod having a desirable feel of writing.

### Modifications

Although the axis portion 241 of the central rod 24 is formed from a carbon material in the embodiment described above, the material is not limited to this. Various materials can be used that have some strength when formed into a rod-shaped body and that allow for formation of the grooves Gv1 and Gv2 on one end portion. For example, metal, such as stainless steel, can be used to form the axis portion 241. In this way, a conductive material, such as a carbon material and metal, can be used to form at least the axis portion 241 in the central rod 24, and a similar central rod can be used to provide the electronic pen of the capacitance system.

Although two grooves Gv1 and Gv2 are provided at different positions in the longitudinal direction on one end portion of the axis portion 241 in the embodiment described above, the arrangement is not limited to this. It is only necessary that at least one groove be provided on one end portion of the axis portion 241. In this case, it is also only necessary to provide one protrusion Pr1 corresponding to the groove Gv1 on the inner wall surface of the hole 242H of the pen tip portion 242. However, it may be preferable to provide two grooves Gv1 and Gv2 on the axis portion 241 and two protrusions Pr1 and Pr2 on the inner wall surface of the hole 242H of the pen tip portion 242 to more firmly attach the pen tip portion 242 to the axis portion 241 and maintain the attached state.

The grooves provided on one end portion of the axis portion 241 and the protrusions provided on the inner wall surface of the hole 242H of the pen tip portion 242 can be provided in various modes. For example, a plurality of grooves may be formed at intervals around the side surface of one end portion of the axis portion 241 such that a ring shape is formed when the grooves are connected. In this case, the protrusions Pr1 and Pr2 corresponding to the grooves of the axis portion 241 can be formed at intervals on the inner wall surface of the hole 242H of the pen tip portion 242 along the inner wall surface such that a ring shape is formed when the protrusions are connected. In addition, three or more grooves and protrusions can be provided in the axial direction, and the width of the grooves and the width of the protrusions can be adjusted appropriately to be of various widths.

Although the grooves Gv1 and Gv2 are provided on the axis portions 241 and the protrusions Pr1 and Pr2 are provided on the pen tip portion 242 in the embodiment described above, the arrangement is not limited to this. The protrusions may be formed around the side surface of one end portion of the axis portion 241, and the corresponding grooves may be provided on the inner wall surface of the hole 242H of the pen tip portion 242. However, for the overall strength of the pen tip portion 242, it may be preferable to provide the grooves Gv1 and Gv2 on the axis portion 241 and provide the protrusions Pr1 and Pr2 on the pen tip portion 242 as in the embodiment described above.

In the embodiment described above, the pen tip portion 242 is formed from a polyacetal resin, or formed by mixing polyparaphenylene terephthalamide fibers with a polyacetal resin, or formed by two-color molding of an elastomer and a polyacetal resin. However, the material is not limited to these. Various resins other than the polyacetal resin, such as a PA resin, a PET resin, a PC resin, and an ABS resin, can be used as resin materials as also described above.

The fibrous material may be a material other than the polyparaphenylene terephthalamide fibers. For example, various other fibers, such as carbon fibers and glass fibers, can be used. However, both reduction of abrasion of the pen tip portion and reduction of the load on the operation surface can be achieved by using the highly strong flexible polyparaphenylene terephthalamide fibers. In addition, various materials, such as synthetic rubber and silicone rubber, can be used as elastomers.

It is to be noted that the embodiment of the present disclosure is not limited to the foregoing embodiment, and that various changes can be made without departing from the spirit of the present disclosure.

1. An electronic pen comprising:
a central rod including an axis portion and a pen tip portion, the axis portion having a rod-shaped body and one or more grooves defined along a circumference of a side surface on one end side of the rod-shaped body, and the pen tip portion including a hole into which the one end side of the axis portion is plugged and including one or more protrusions defined on an inner wall surface of the hole, wherein the one or more protrusions are to be fitted to the one or more grooves of the axis portion; and
a casing that includes a cylindrical body, includes an opening at one end, and includes an installation portion for the central rod inside, wherein
when a rear end side of the central rod is inserted into the opening of the casing and installed on the installation portion, at least one of the one or more grooves of the axis portion of the central rod are positioned outside the opening of the casing.

2. The electronic pen according to claim 1, wherein two grooves of the axis portion of the central rod are provided at two places separated in a longitudinal direction of the axis portion, and
when the rear end side of the central rod is inserted into the opening of the casing and installed on the installation portion, at least the groove toward the end side, out of the two grooves at the two places of the axis portion of the central rod, is positioned outside the opening of the casing.

3. The electronic pen according to claim 1, wherein, when the rear end side of the central rod is inserted into the opening of the casing and installed on the installation portion, a predetermined part of the pen tip portion on the rear end side is positioned inside the casing.

4. The electronic pen according to claim 1, wherein, when the rear end side of the central rod is inserted into the opening of the casing and installed on the installation portion, a side surface of a predetermined part of the pen tip portion on the rear end side and an inner wall surface of a part of the opening of the casing face each other in parallel being spaced apart from each other.

5. The electronic pen according to claim 1, wherein the axis portion of the central rod is formed of a carbon material.

6. The electronic pen according to claim 1, wherein the pen tip portion of the central rod is formed of a fibrous material mixed resin including a fibrous material mixed with a base resin.

7. The electronic pen according to claim 1, wherein the pen tip portion of the central rod is formed by mixing polyparaphenylene terephthalamide fibers as a fibrous material with a polyacetal resin as a base resin.

8. The electronic pen according to claim 1, wherein the pen tip portion of the central rod is formed by two-color molding using different materials for a tip part and a rear part.

9. The electronic pen according to claim 1, wherein the pen tip portion of the central rod includes a tip part and a rear part, and the pen tip portion is formed by two-color molding using an elastomer for the tip part and a polyacetal resin for the rear part.

10. An electronic pen central rod comprising:
an axis portion that is a rod-shaped body and that is provided with one or more grooves along a circumference of a side surface on one end side of the rod-shaped body; and
a pen tip portion that includes a hole into which the one end side of the axis portion is plugged and that is provided with one or more protrusions on an inner wall surface of the hole, wherein the one or more protrusions are to be fitted to the one or more grooves of the axis portion.

11. The electronic pen central rod according to claim 10, wherein the one or more grooves of the axis portion are provided at two places separated in a longitudinal direction of the axis portion.

12. The electronic pen central rod according to claim 10, wherein the axis portion is formed of a carbon material.

13. The electronic pen central rod according to claim 10, wherein the pen tip portion is formed of a fibrous material mixed resin including a fibrous material mixed with a base resin.

14. The electronic pen central rod according to claim 10, wherein the pen tip portion is formed by mixing polyparaphenylene terephthalamide fibers as a fibrous material with a polyacetal resin as a base resin.

15. The electronic pen central rod according to claim 10, wherein the pen tip portion is formed by two-color molding using different materials for a tip part and a rear part.

16. The electronic pen central rod according to claim 10, wherein the pen tip portion includes a tip part and a rear part, and the pen tip portion is formed by two-color molding using an elastomer for the tip part and a polyacetal resin for the rear part.
